(19) United States
(12) Patent Application Publication
(10) Pub. No.: US 2025/0251902 A1
(43) Pub. Date: Aug. 7, 2025

(54) Record Check

(71) Applicant: SuperScope Technologies Inc., Geneva, IL (US)

(72) Inventors: Paul Mathis, Geneva, IL (US); Brian Aiken, Geneva, IL (US)

(21) Appl. No.: 18/435,713

(22) Filed: Feb. 7, 2024

(51) Int. Cl. G06F 3/16

(52) U.S. Cl. CPC G06F 3/165

(57) ABSTRACT

An audio recording system and method automatically set a record level for recording audio by capturing a portion of user audio data after prompting the user audio visually and analyzing that portion of the user audio data to determine an appropriate record level. The determined record level is then applied while recording a remaining portion of the user audio data, and the recorded portion may be played back to the user to confirm that the determined setting is suitable.

### TECHNICAL FIELD

The present disclosure is related generally to audio recording devices, and, more particularly, to a system and method for performing an automatic record parameter check in an audio recording system or device.

### BACKGROUND

While audio recording devices are known, it has been a long-standing problem to set the recording parameter levels suitably to provide optimal recording performance. One traditional method is to have a sound technician adjust recording parameters while a user provides test utterances, e.g., by counting, reciting the alphabet, etc. In this way, the sound technician can eventually “zero in” on the necessary settings to provide good recording quality. Settings may vary but generally include at least an input gain (set to avoid clipping) as well as other values in some cases.

Similarly, informal users may set the recording values themselves as they play or utter example phrases or segments. However, an untrained user is unlikely to arrive at optimal or even acceptable settings on their own, thus requiring post-recording repair of the recording or the hiring of trained assistance.

While the present disclosure is directed to a system that can eliminate certain shortcomings noted in this Background section, it should be appreciated that such a benefit is neither a limitation on the scope of the disclosed principles nor of the attached claims, except to the extent expressly noted in the claims. Additionally, the discussion of technology in this Background section is reflective of the inventors' own observations, considerations, and thoughts, and is in no way intended to accurately catalog or comprehensively summarize the art currently in the public domain. As such, the inventors expressly disclaim this section as admitted or assumed prior art. Moreover, the identification herein of a desirable course of action reflects the inventors' own observations and ideas, and should not be assumed to indicate an art-recognized desirability.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a perspective view of an audio system in accordance with one or more embodiments of the described principles;

FIG. 2 is a simplified modular electronic view showing a set of suitable components for an audio system in accordance with one or more embodiments of the described principles;

FIG. 3 is a flow chart illustrating an auto record check process in accordance with one or more embodiments of the described principles;

FIG. 4A is a circuit diagram illustrating a sub circuit representation of the described functions in accordance with one or more embodiments of the described principles;

FIG. 4B is a circuit diagram illustrating a sub circuit representation of the described functions in accordance with one or more embodiments of the described principles;

FIG. 4C is a circuit diagram illustrating a sub circuit representation of the described functions in accordance with one or more embodiments of the described principles; and

FIG. 4D is a circuit diagram illustrating a sub circuit representation of the described functions in accordance with one or more embodiments of the described principles.

### DETAILED DESCRIPTION

Before presenting a fuller discussion of the disclosed principles, an overview is given to aid the reader in understanding the later discussion. As noted above, it is often difficult or time-consuming for users to arrive at the correct recording settings in a given environment, especially without the assistance of a trained technician.

In overview, the described system and method allow the user to activate an automatic process to set the recording values. The automatic process, once activated, samples the user's voice (or instrument etc.) and performs a settings adjustment to yield a settings configuration that provides good technical sound quality in the eventual recording. In other words, the system automatically sets a record level for recording audio based on a portion of user audio data and applies that record level while recording a remaining portion of the user audio data. As used herein, the term “record level” includes any or all of input sensitivity, input levels, and record levels). The system may then optionally play the recorded sample back to the user to confirm that the determined settings are suitable. In an embodiment, a display may be presented to the user reporting the selected settings and asking the user if they would like to replay the recorded sample file.

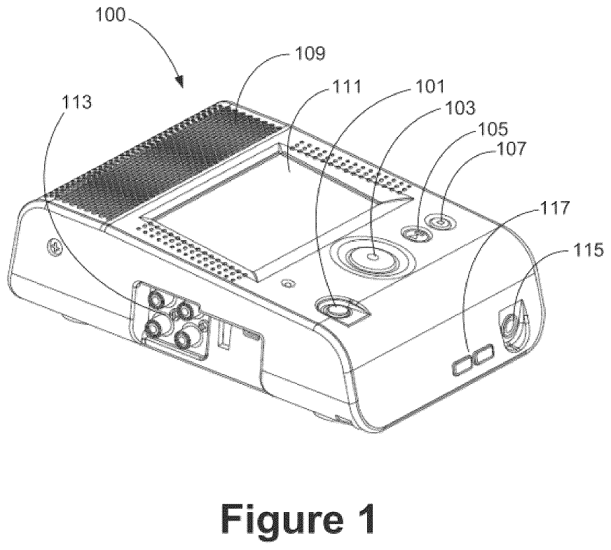

Referring to FIG. 1, this figure shows an exemplary audio device 100 within which embodiments of the described principles may be implemented. The illustrated device 100 includes various adjustment interface elements 101, 103, 105, 107 as well as speakers 109 and a screen 111. The screen 111 may be a display-only screen or an interactive touch screen, and provides visual feedback and information for the user's use of the device 100.

In an embodiment, one or more input jacks 115 and output jacks 113 may be included, as well as any additional user interface elements 117. It will be appreciated that any device surface, including the opposite side, back and bottom, not shown, may be used to expose additional UI elements, inputs, outputs and power options.

In the illustrated embodiment, the device 100 exposes a number of playback controls but no or few recording settings controls. In other words, beyond starting and stopping a recording, various embodiments of the described principles eliminate the need for detailed recording settings by the user.

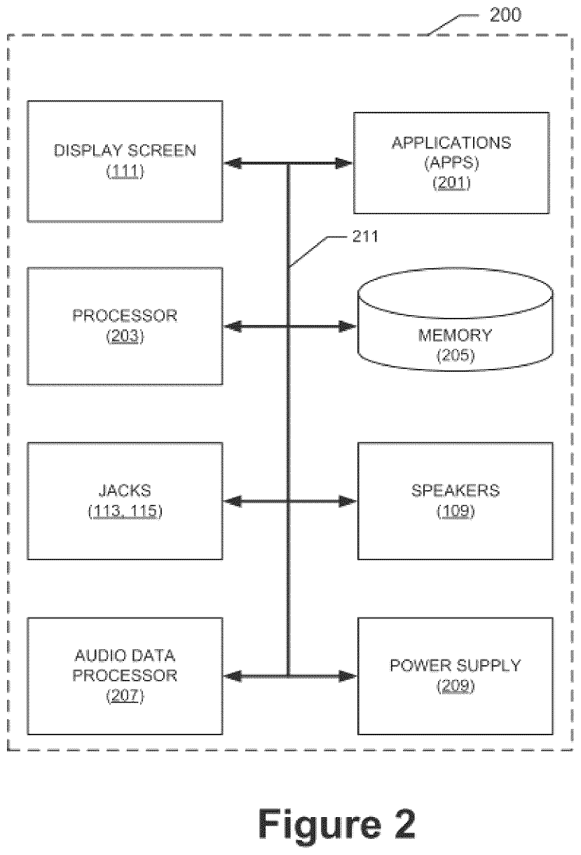

Before discussing the device functionality in detail, a simplified modular electronic view showing a set of suitable components for an audio system is given in FIG. 2 to illustrate a potential electronic architecture 200 for the device. As can be seen, the device architecture 200 in the illustrated embodiment includes the display screen 111, applications (e.g., programs) 201, a processor 203, a memory 205, various input components, e.g., jacks 113, 115, and one or more output components such as one or more speakers 109.

The processor 203 may be any of a microprocessor, microcomputer, application-specific integrated circuit, or the like. For example, the processor 203 can be implemented by one or more microprocessors or controllers from any desired family or manufacturer. Similarly, the memory 205 may reside on the same integrated circuit as the processor 203. Additionally or alternatively, the memory 205 may be accessed via a network, e.g., via cloud-based storage. The memory 205 may include a random access memory (i.e., Synchronous Dynamic Random Access Memory (SDRAM), Dynamic Random Access Memory (DRAM), RAMBUS Dynamic Random Access Memory (RDRM) or any other type of random access memory device). Additionally or alternatively, the memory 205 may include a read only memory (i.e., a hard drive, flash memory or any other desired type of memory device).

The information that is stored by the memory 205 can include program code associated with one or more operating systems or applications as well as informational data, e.g., program parameters, process data, etc. The operating system and applications are typically implemented via executable instructions stored in a non-transitory computer readable medium (e.g., memory 205) to control basic functions of the electronic device. Such functions may include, for example, interaction among various internal components and storage and retrieval of applications and data to and from the memory 205.

Further with respect to the applications 201, these typically utilize the operating system to provide more specific functionality, such as file system service and handling of protected and unprotected data stored in the memory 205. Although many applications may provide standard or required functionality of the user device 200, in other cases applications provide optional or specialized functionality, and may be supplied by third party vendors or the device manufacturer.

With respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

The device 200 may include an audio data processor 207 which implements the image data manipulations described herein. The image data processing engine 207 may be implemented as non-transitory computer-executable instructions, e.g., stored in device memory, which are read and executed by the device processor 203. Alternatively, the image data processing engine 207 may be implemented as a separate internal module that performs the described functions, with or without support from the device processor 203.

In an embodiment, a power supply 209, such as a battery or fuel cell, may be included for providing power to the device and its components. All or some of the internal components communicate with one another by way of one or more shared or dedicated internal communication links 211, such as an internal bus.

In an embodiment, the device 100 is programmed such that the processor 203 and memory 205 interact with the other components of the device 100 to perform certain functions. The processor 203 may include or implement various modules and execute programs for initiating different activities such as launching an application, transferring data, and toggling through various graphical user interface objects (e.g., toggling through various display icons that are linked to executable applications).

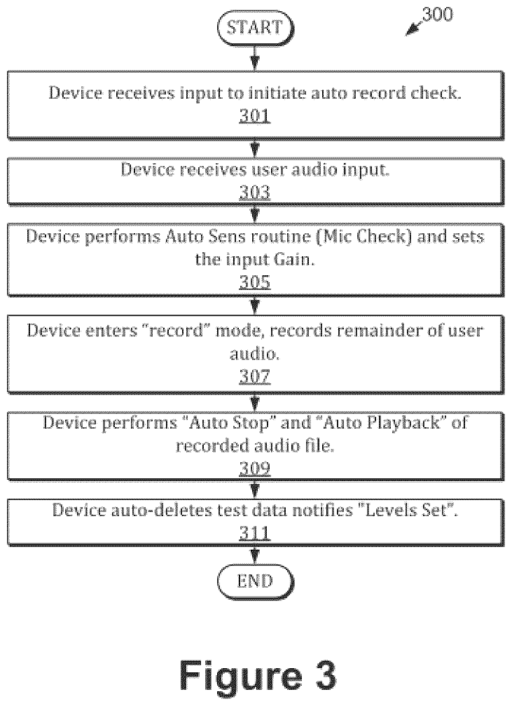

Turning to FIG. 3, this figure shows a flowchart of the device's process for automatic record settings acquisition. As noted above, processes executed by the device 100, 200 are carried out by the processor 203 via the retrieval (from nontransitory computer-readable medium) and execution of computer-executable instructions.

At stage 301 of the illustrated process 300, the device processor 203 receives a user input (e.g., a menu selection on the device screen) requesting an auto record check (autotesting and acquisition of record settings). At this point, the processor prompts the user to give a sustained utterance, and at stage 303, the device receives from the user the sustained utterance via a microphone, such as a count-off by the user of the numbers 1-12. The device may provide a prompt for the user to provide the needed audio via visual or audible instructions, and in an embodiment, the device display shows the countdown for the user to read aloud. In another embodiment, both an audible and visual instruction are provided to prompt the user to provide the needed audio.

During the reading, the device performs an Auto Sens routine (Mic Check) via its processor 203 and sets the input Gain over the course of about 7 seconds. It will be appreciated that longer or shorter times may be used from this step without departing from the scope of the described principles.

The device then automatically enters “record” mode and records audio of remainder of the user's utterance, i.e., “. . . 3, 2, 1, 0,” at stage 305. The device display may change during the Auto Sens routine, and in an embodiment, a record indication activates, e.g., goes from flashing to solid, when the test recording begins. Having recorded a certain amount of audio, the device then at stage 307 prompts the user to play back the recorded audio file, e.g., through speaker 109. The user hears the playback and confirms (either explicitly or by inaction) that the audio recording values are suitable.

Finally at stage 313, the device in an embodiment provides a notification such as “Levels Set” via the device screen. At this point, the device is ready for the user to record the desired audio. The test file may be deleted at this point or only after the user returns to the home screen

Although the above steps may be executed via the processor of the device or via an ancillary processor or microcomputer, a circuit representation of the value setting is given to enable other implementations and to provide a fuller understanding of the process.

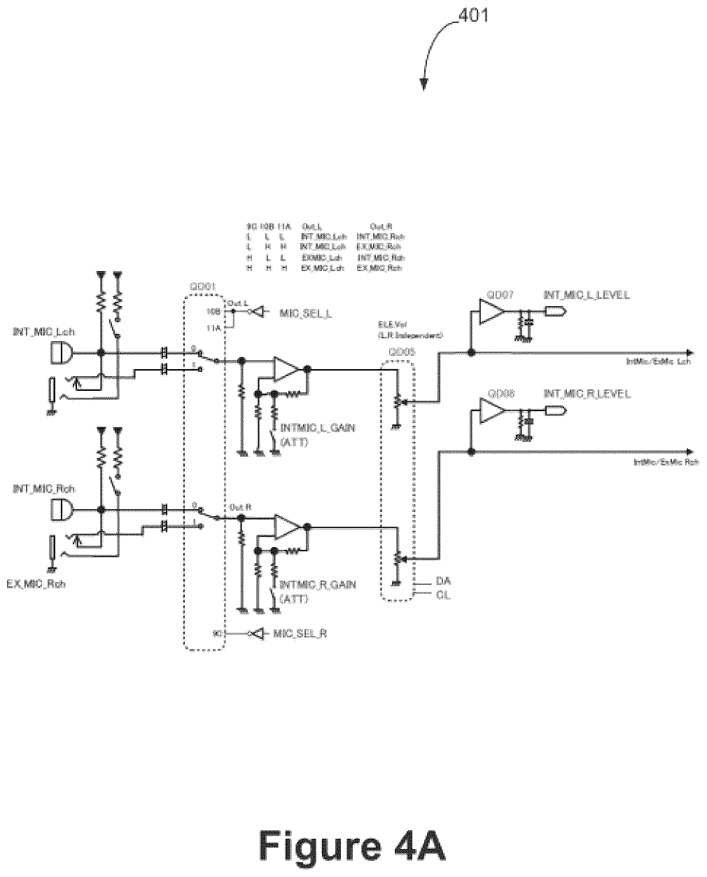

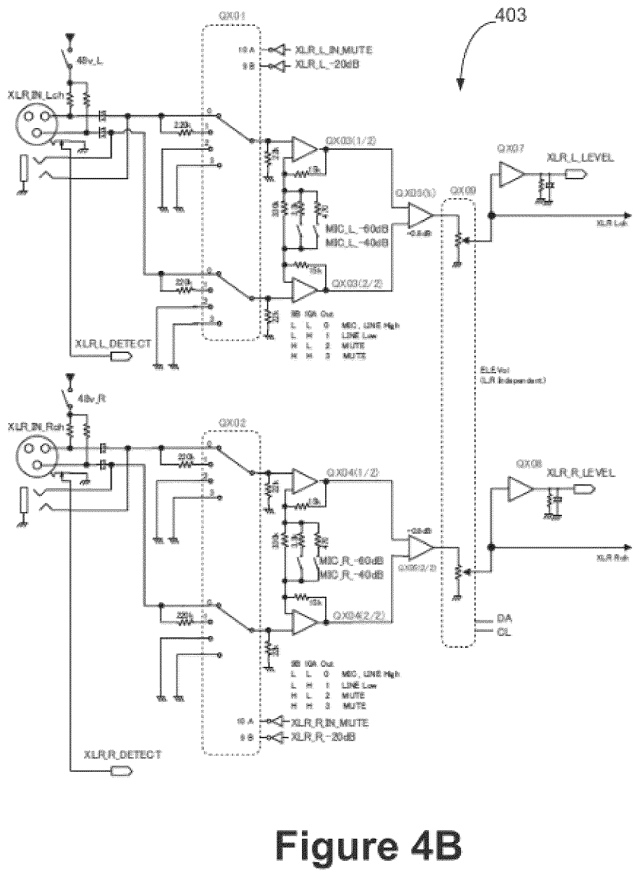

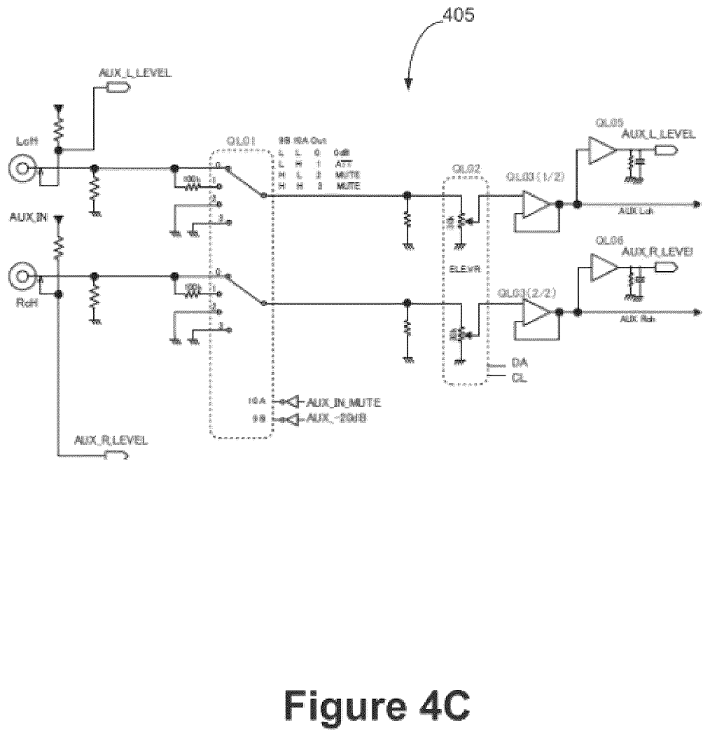

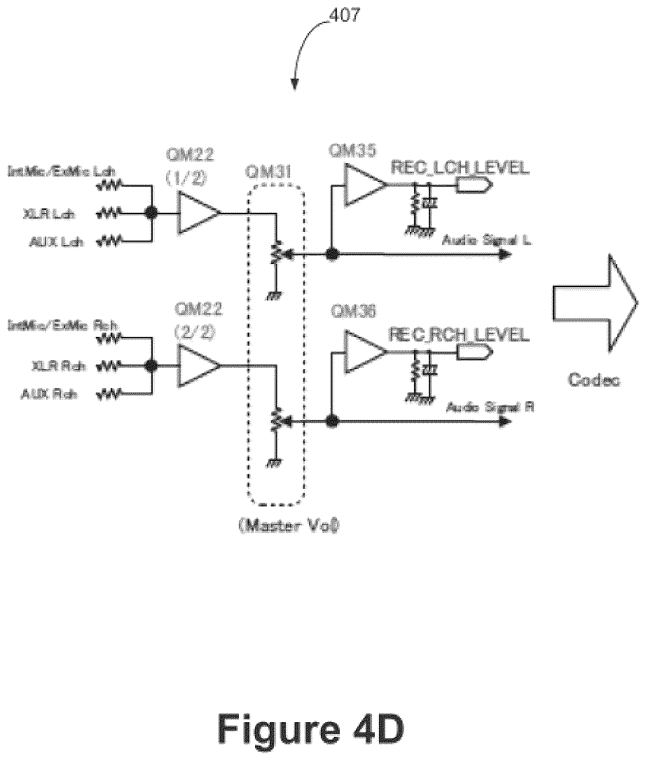

Thus, FIGS. 4A-D show a circuit schematic illustrating the Record Check process via an alternative circuit representation. The illustrated circuit includes a number of inputs including XLR input (XLR_IN_Lch, XLR_IN_Rch) in sub circuit 403 (FIG. 4B), IntMic (Int_Mic_Lch, Int_Mic_Rch) in sub circuit 401 (FIG. 4A), EXMic input (EX_Mic_Rch) (401) and an AUX input (Aux LcH, RcH) in sub circuit 405 (FIG. 4C). The circuit 407 shown in FIG. 4D takes the outputs of the preceding circuits and generates record levels (REC_Rch_Level and (REC_Lch_Level) for use by the device codec or other audio processing circuitry or routine.

With respect to the XLR input, the circuit 403 detects the maximum of the input sound level and sets it in the most suitable input sensitivity for the level via four parameters QX01,QX02,QX03,QX04 corresponding to one of −40 dBu, −60 dBu, −4 dBu and +16 dBu. The input level reads a value of QX07, QX08 by the microcomputer and the unit compares the signal level and threshold of detection. And then attenuates the input electronically via Vol QM31. The IntMic/EXMic and the AUX are treated the same as the XLR input, and all input terminals are controlled by Lch, Rch independence simultaneously. Mixture amplifier signal QM22 is essentially a −6 dB function, but gives a level when the level of QM35 does not reach the threshold.

In this way, the gain level for the specific audio input given a certain setup and environment can be automatically set without user intervention other than as described above. As noted, the described functions can be implemented via a circuit, a processor/microcomputer or, as just discussed, a combination of both.

It will be appreciated that a system for automatic gain control in an audio capture device has been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. An audio recording method for use in an audio recording device, the method comprising:
receiving user input indicating that a user desires to make an audio recording using the device;
prompting the user to input audio data via visual and audible prompting;
receiving a first portion of the audio data input by the user and performing a routine that automatically determines a record level suitable for the received audio;
setting a record level for the device automatically in accordance with the determined record level resulting from the routine that automatically determines a record level;
subsequently, automatically recording a second portion of the audio data input by the user; and
playing the recorded second portion back to the user.

2. The audio recording method in accordance with claim 1, wherein the step of receiving user input indicating that a user desires to make an audio recording using the device further comprises detecting that the audio recording device has been powered on.

3. The audio recording method in accordance with claim 1, wherein the step of receiving user input indicating that a user desires to make an audio recording using the device further comprises detecting that a mic or line source has been plugged into the audio recording device.

4. The audio recording method in accordance with claim 1, wherein the step of receiving user input indicating that a user desires to make an audio recording using the device further comprises detecting that recording on the audio recording device has been enabled.

5. The audio recording method in accordance with claim 1, wherein the step of prompting the user to input audio data further comprises using a display of the audio recording device.

6. The audio recording method in accordance with claim 1, wherein the step of prompting the user to input audio data further comprises using a speaker of the audio recording device.

7. An audio recording device for automatically setting a record level for a user, the audio recording device comprising:
a display for receiving input from the user and conveying visual information to the user;
an audio input to receive audio information for recording;
an audio speaker; and
a processor configured to receive user input indicating that a user desires to make an audio recording using the device, prompt the user audibly and visually to input audio data, receive a first portion of the audio data input by the user and perform a routine to determine a record level suitable for the received audio, set a record level for the device in accordance with the determined record level resulting from the routine, subsequently, automatically record a second portion of the audio data input by the user, and play the recorded second portion back to the user via the speaker.

8. The audio recording device in accordance with claim 7, wherein the processor is configured to receive user input indicating that a user desires to make an audio recording using the device by detecting that the audio recording device has been powered on.

9. The audio recording device in accordance with claim 7, further comprising a mic or line source input, and wherein the processor is configured to receive user input indicating that a user desires to make an audio recording using the device by detecting that a mic or line source has been plugged into the mic or line source input.

10. The audio recording device in accordance with claim 7, wherein the audio recording device includes a record mode and wherein the processor is configured to receive user input indicating that a user desires to make an audio recording using the device by detecting that the record mode has been activated.

11. The audio recording device in accordance with claim 7, wherein the processor is configured to prompt the user to input audio data via the display.

12. The audio recording device in accordance with claim 7, wherein the processor is configured to prompt the user to input audio data via the speaker.

13. A computer-readable medium having thereon computer-executable instructions for automatically setting a record level for a user of an audio recording device, the instructions comprising instructions for:
receiving user input indicating that the user desires to make an audio recording using the device;
prompting the user audibly and visually to input audio data;
receiving a first portion of the audio data input by the user;
determining a record level suitable for the first portion of received audio;
set a record level for the device in accordance with the determined record level; and
automatically recording a second portion of the audio data input by the user, and playing the recorded second portion back to the user.

14. The computer-readable medium in accordance with claim 13, wherein the instructions for receiving user input indicating that a user desires to make an audio recording using the device further comprise instructions for detecting that the audio recording device has been powered on.

15. The computer-readable medium in accordance with claim 13, wherein the instructions further comprise instructions for detecting that a mic or line source has been plugged into the mic or line source input.

16. The computer-readable medium in accordance with claim 13, wherein the instructions for receiving user input indicating that a user desires to make an audio recording using the device further comprise instructions for detecting that the record mode has been activated.

17. The computer-readable medium in accordance with claim 13, wherein the instructions further comprise instructions for prompting the user to input audio data by providing a visual prompt to the user via the display.

18. The computer-readable medium in accordance with claim 13, wherein the processor is configured to prompt the user to input audio data by providing an audible prompt to the user via the speaker.

19. An audio recording method on a recording device, the method comprising:
prompting a user to provide audio data having a time duration via visual and audible prompting;
automatically determining a record level suitable for the provided audio data based on audio received during only a portion of the time duration, leaving a remainder of the duration;
setting a record level for subsequent recording in accordance with the determined record level; and
recording during the remainder of the duration using the set record level.

20. The audio recording method in accordance with claim 19, further comprising audibly playing the audio recorded during the remainder of the duration back to the user.

21. The audio recording method in accordance with claim 19, wherein the step of prompting a user to provide audio data is initiated upon detecting that the audio recording device has been powered on.

22. The audio recording method in accordance with claim 19, wherein the step of prompting a user to provide audio data is initiated upon detecting that a mic or line source has been plugged into the audio recording device.

23. The audio recording method in accordance with claim 19, wherein the step of prompting a user to provide audio data is initiated upon detecting that recording on the audio recording device has been enabled.

24. The audio recording method in accordance with claim 19, wherein visual prompting of the user to input audio data comprises using a display of the audio recording device.

25. The audio recording method in accordance with claim 19, wherein audible prompting of the user to input audio data comprises using a speaker of the audio recording device.
